(19) United States
(12) Patent Application Publication
(10) Pub. No.: US 2024/0253062 A1
(43) Pub. Date: Aug. 1, 2024

(54) MECHANIZED CENTRIFUGE WITH SOLIDS CONTENT ANALYZER TO CONDITION DRILLING FLUIDS

(71) Applicant: SAUDI ARABIAN OIL COMPANY, Dhahran (SA)

(72) Inventors: Tulio D. Olivares Antunez, Khobar (SA); Rami Adel Sindi, Damman (SA); Rafael M. Pino, Damman (SA)

(73) Assignee: SAUDI ARABIAN OIL COMPANY, Dhahran (SA)

(21) Appl. No.: 18/161,556

(22) Filed: Jan. 30, 2023

(51) Int. Cl. B04B 13/00; B01D 21/26; B01D 21/34; B04B 9/10; E21B 21/06

(52) U.S. Cl. CPC B04B 13/00; B01D 21/262; B01D 21/34; B04B 9/10; E21B 21/065; B04B 2013/006

(57) ABSTRACT

A system includes a centrifuge, a centrifuge feed pit, a centrifuge discharge pit, and a computer system. The centrifuge receives solids-laden drilling fluid via a centrifuge pump and discharges conditioned drilling fluid and separated solids using centrifuge operational parameters. The centrifuge feed pit comprises the solids-laden drilling fluid and a first solids content sensor. The centrifuge discharge pit comprises the conditioned drilling fluid and a second solids content sensor. The computer system is configured to analyze results from the first solids content sensor and the second solids content sensor using a set of goal drilling fluid parameters and send an instruction to the centrifuge based on the analyzed results of the solids content sensors. The instruction comprises a first instruction to stop the centrifuge or a second instruction to adjust the centrifuge operational parameters.

### BACKGROUND

Hydrocarbons are located in porous formations far beneath the Earth's surface. Wells are drilled into these formations to access and produce the hydrocarbons. Wells are drilled using a drill string and drilling fluid. Drilling fluid is specially designed to manage downhole pressures, ensure formation stability, lubricate and cool the drill bit, remove wellbore cuttings, and prevent formation damage. Further, drilling fluid is recycled throughout the drilling process. Thus, drilling fluid will circulate through the well many times before the drilling fluid is replaced. As mentioned above, the drilling fluid is designed to hold and transport cuttings out of the well. In order for the drilling fluid to be recirculated, the solids must be removed from the drilling fluid. Removal of the solids from the drilling fluid is called conditioning.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

This disclosure presents, in accordance with one or more embodiments, methods and systems for conditioning drilling fluid. The system includes a centrifuge, a centrifuge feed pit, a centrifuge discharge pit, and a computer system. The centrifuge is configured to receive solids-laden drilling fluid via a centrifuge pump and discharge conditioned drilling fluid and separated solids using centrifuge operational parameters. The centrifuge feed pit comprises the solids-laden drilling fluid and a first solids content sensor. The centrifuge discharge pit comprises the conditioned drilling fluid and a second solids content sensor. The computer system is electronically connected to the first solids content sensor, the second solids content sensor, and the centrifuge. The computer system is configured to analyze results from the first solids content sensor and the second solids content sensor using a set of goal drilling fluid parameters and send an instruction to the centrifuge based on the analyzed results of the solids content sensors. The instruction comprises a first instruction to stop the centrifuge or a second instruction to adjust the centrifuge operational parameters.

The method includes pumping solids-laden drilling fluid from a centrifuge feed pit to a centrifuge using a centrifuge pump, measuring a first solids content of the solids-laden drilling fluid using a first solids content sensor connected to the centrifuge feed pit, conditioning the solids laden drilling fluid using the centrifuge and centrifuge operational parameters, and discharging conditioned drilling fluid from the centrifuge to a centrifuge discharge pit. The method also includes measuring a second solids content of the conditioned drilling fluid using a second solids content sensor connected to the centrifuge discharge pit, analyzing the first solids content and the second solids content using a computer system and a set of goal drilling fluid parameters, and sending an instruction to the centrifuge based on the solids content analyzation, wherein the instruction comprises a first instruction to stop the centrifuge or a second instruction to adjust the centrifuge operational parameters.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 shows an example well site in accordance with one or more embodiments.

FIG. 2 shows a mechanized centrifuge with a solids content analyzer in accordance with one or more embodiments.

FIG. 3 shows a flowchart in accordance with one or more embodiments.

FIG. 4 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

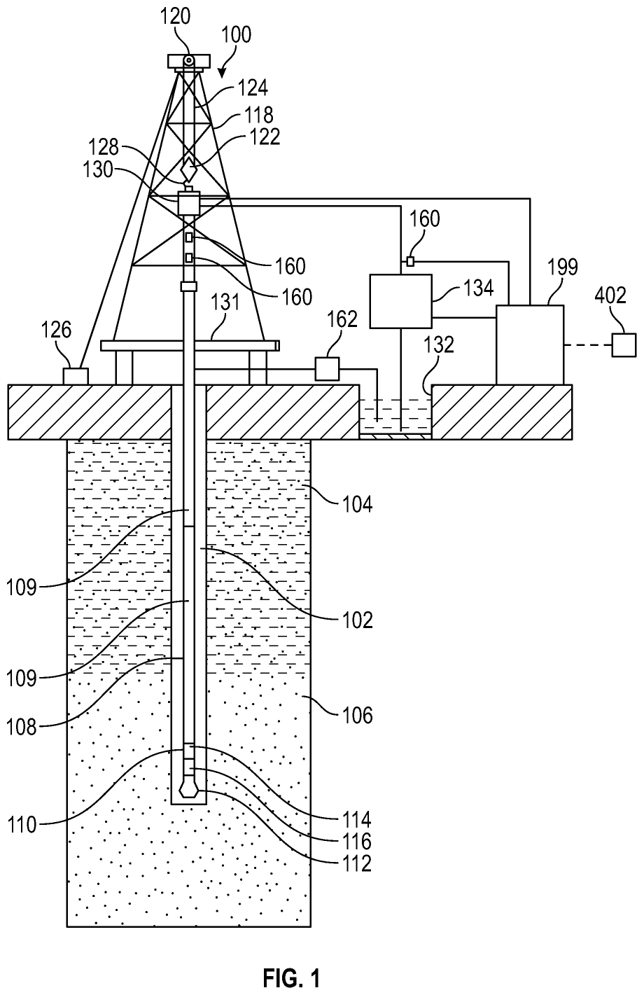

FIG. 1 shows an example well site (100) in accordance with one or more embodiments. In general, well sites may be configured in a myriad of ways. Therefore, well site (100) is not intended to be limiting with respect to the particular configuration of the drilling equipment. The well site (100) is depicted as being on land. In other examples, the well site (100) may be offshore, and drilling may be carried out with or without use of a marine riser. A drilling operation at well site (100) may include drilling a wellbore (102) into a subsurface including various formations (104, 106). For the purpose of drilling a new section of wellbore (102), a drill string (108) is suspended within the wellbore (102).

The drill string (108) may include one or more drill pipes (109) connected to form conduit and a bottom hole assembly (BHA) (110) disposed at the distal end of the conduit. The BHA (110) may include a drill bit (112) to cut into the subsurface rock. The BHA (110) may include measurement tools, such as a measurement-while-drilling (MWD) tool (114) and logging-while-drilling (LWD) tool 116. Measurement tools (114, 116) may include sensors and hardware to measure downhole drilling parameters, and these measurements may be transmitted to the surface using any suitable telemetry system known in the art. Herein, the term surface is defined as any location located outside of the wellbore (102), such as somewhere on the Earth's surface, on a man-made object located on the Earth's surface, etc. The BHA (110) and the drill string (108) may include other drilling tools known in the art but not specifically shown.

The drill string (108) may be suspended in wellbore (102) by a derrick (118). A crown block (120) may be mounted at the top of the derrick (118), and a traveling block (122) may hang down from the crown block (120) by means of a cable or drilling line (124). One end of the cable (124) may be connected to a drawworks (126), which is a reeling device that may be used to adjust the length of the cable (124) so that the traveling block (122) may move up or down the derrick (118). The traveling block (122) may include a hook (128) on which a top drive (130) is supported.

The top drive (130) is coupled to the top of the drill string (108) and is operable to rotate the drill string (108). Alternatively, the drill string (108) may be rotated by means of a rotary table (not shown) on the drilling floor (131). Drilling fluid (commonly called mud) may be stored in a mud pit (132), and at least one pump (134) may pump the mud from the mud pit (132) into the drill string (108). The mud may flow into the drill string (108) through appropriate flow paths in the top drive (130) (or a rotary swivel if a rotary table is used instead of a top drive to rotate the drill string (108)).

In one implementation, a system (199) may be disposed at or communicate with the well site (100). System (199) may control at least a portion of a drilling operation at the well site (100) by providing controls to various components of the drilling operation. In one or more embodiments, system (199) may receive data from one or more sensors (160) arranged to measure controllable parameters of the drilling operation. As a non-limiting example, sensors (160) may be arranged to measure WOB (weight on bit), RPM (drill string rotational speed), GPM (flow rate of the mud pumps), and ROP (rate of penetration of the drilling operation).

Sensors (160) may be positioned to measure parameter(s) related to the rotation of the drill string (108), parameter(s) related to travel of the traveling block (122), which may be used to determine ROP of the drilling operation, and parameter(s) related to flow rate of the pump (134). For illustration purposes, sensors (160) are shown on drill string (108) and proximate mud pump (134). The illustrated locations of sensors (160) are not intended to be limiting, and sensors (160) could be disposed wherever drilling parameters need to be measured. Moreover, there may be many more sensors (160) than shown in FIG. 1 to measure various other parameters of the drilling operation. Each sensor (160) may be configured to measure a desired physical stimulus.

During a drilling operation at the well site (100), the drill string (108) is rotated relative to the wellbore (102), and weight is applied to the drill bit (112) to enable the drill bit (112) to break rock as the drill string (108) is rotated. In some cases, the drill bit (112) may be rotated independently with a drilling motor. In further embodiments, the drill bit (112) may be rotated using a combination of the drilling motor and the top drive (130) (or a rotary swivel if a rotary table is used instead of a top drive to rotate the drill string (108)). While cutting rock with the drill bit (112), mud is pumped into the drill string (108).

The mud flows down the drill string (108) and exits into the bottom of the wellbore (102) through nozzles in the drill bit (112). The mud in the wellbore (102) then flows back up to the surface in an annular space between the drill string (108) and the wellbore (102) with entrained cuttings. The mud with the cuttings is returned to the pit (132) to be circulated back again into the drill string (108).

In accordance with one or more embodiments, the mud may be conditioned, and the cuttings may be removed from the mud prior to recirculation into the wellbore (102). FIG. 1 shows mud conditioning equipment (162) that may be used to condition the mud. The mud conditioning equipment (162) is shown in FIG. 1 as being located between the return line of the wellbore (102) and the mud pit (132). However, the mud conditioning equipment (162) may be located anywhere in the flow path of the mud without departing from the scope of the disclosure herein.

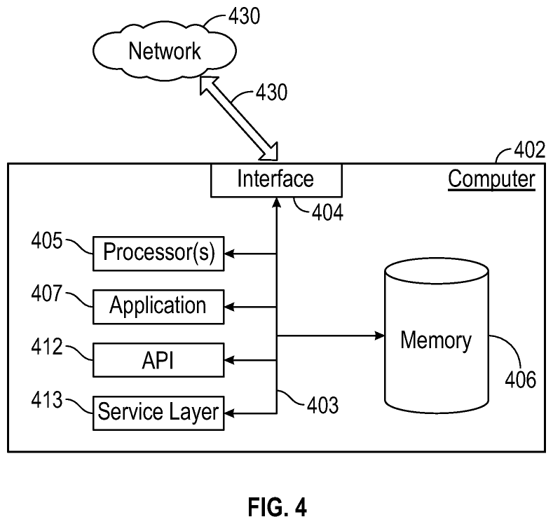

In accordance with one or more embodiments, the mud conditioning equipment (162) may include any type of mud conditioning equipment known in the art, such as shale shakers, degassers, flare stacks, settling pits, desanders, desilters, centrifuges, etc. In one or more embodiments, the drilling operation may be controlled by the system (199). Specifically, the system (199) may be or may include one or more computers (402). The computer (402) system is further outlined in FIG. 4 below.

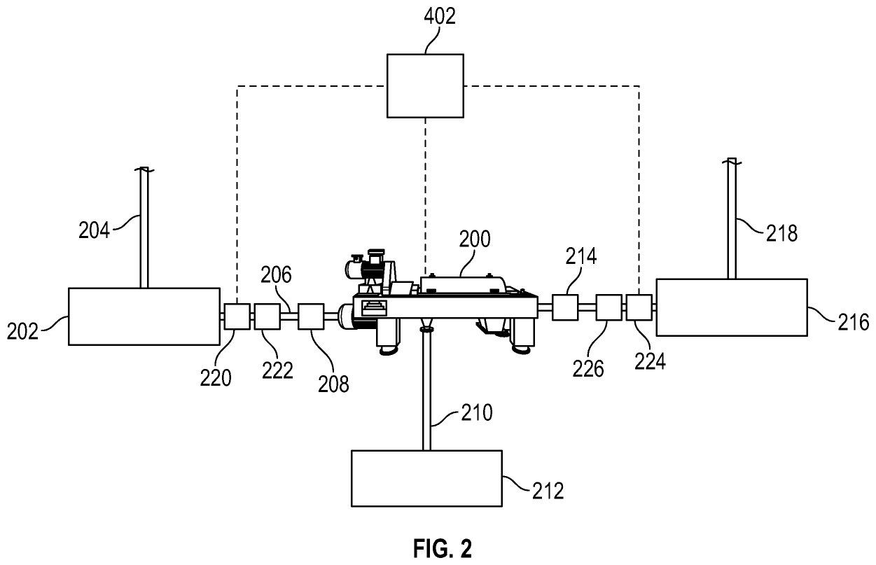

FIG. 2 shows a mechanized centrifuge (200) with a solids content analyzer in accordance with one or more embodiments. The centrifuge (200) may be used to remove solids from the drilling fluid. Specifically, and in accordance with one or more embodiments, the centrifuge (200) is used to remove small-diameter solid particles that are unable to be removed from the drilling fluid by other tools, such as shale shakers.

In further embodiments, the centrifuge (200) is used to remove solids that are approximately 2-50 microns in size. The centrifuge (200) includes a conical drum that rotates at a set speed. In accordance with one or more embodiments, the drum may rotate at speeds between 2,000 and 4,000 rotations per minute (rpm). The drilling fluid is fed into one side of the centrifuge (200), and, as the drum rotates, the solids are separated, and the separated solids move up the bowl via a rotating scroll to exit the centrifuge (200). The ability for centrifuges (200) to separate the solids from the drilling fluid is dependent on particle size and particle density of the solids.

As explained above, the properties of drilling fluid are specially set for the drilling operation. As such, it is important that the drilling fluid being recirculated into the wellbore (102) has the required properties. Embodiments disclosed herein are directed to a solids content analyzer that may be used to analyze the properties of the drilling fluid entering and exiting the centrifuge (200). Further, the solids content analyzer may analyze the properties and use that analysis to send commands to the centrifuge (200) to ensure proper conditioning of the drilling fluid.

FIG. 2 outlines the major components of the solids content analyzer. Specifically, the solids content analyzer may include the computer (402), one or more solids content sensors (220, 224), and one or more specific gravity sensors (222, 226). The centrifuge (200) shown in FIG. 2 is an example centrifuge (200) and any brand or centrifuge design may be used without departing from the scope of the disclosure herein.

In accordance with one or more embodiments, the centrifuge (200) is configured to receive solids-laden drilling fluid. The solids-laden drilling fluid may be drilling fluid coming directly or indirectly from the wellbore (102) or may be drilling fluid that has been insufficiently conditioned.

In accordance with one or more embodiments, the solids-laden drilling fluid may be pumped from the wellbore (102) to a centrifuge feed pit (202) via a wellbore discharge line (204) connected to the centrifuge feed pit (202). The wellbore discharge line (204) is configured to transport the solids-laden drilling fluid from the wellbore (102) to the centrifuge feed pit (202).

The solids-laden drilling fluid may be directly or indirectly transported from the wellbore (102). Further one or more other pieces of equipment, such as other mud conditioning equipment (162), may be located between the wellbore (102) and the centrifuge feed pit (202) without departing from the scope of the disclosure herein. The centrifuge feed pit (202) is designed to hold a set volume of the solids-laden drilling fluid. The centrifuge feed pit (202) may be any type of container known in the art, such as an above ground/buried tank or a lined/unlined pit dug into the ground.

The solids-laden drilling fluid may be pumped from the centrifuge feed pit (202) to the centrifuge (200) via a centrifuge feed line (206) that is connected to both the centrifuge feed pit (202) and the centrifuge (200). The centrifuge feed line (206) is configured to transport the solids-laden drilling fluid from the centrifuge feed pit (202) to the centrifuge (200).

A centrifuge pump (208) may be used to pump the solids-laden drilling fluid from the centrifuge feed pit (202) to the centrifuge (200). The centrifuge pump (208) is shown located on the centrifuge feed line (206). However, the centrifuge pump (208) may be connected to or be a part of either the centrifuge feed pit (202) or the centrifuge (200) itself. Further, the centrifuge pump (208) may be any type of pump known in the art without departing from the scope of the disclosure herein.

The centrifuge (200) may be programmed with a set of centrifuge (200) operational parameters that instruct the centrifuge (200) what speed to rotate at. The centrifuge (200) is configured to receive the solids-laden drilling fluid and discharge conditioned drilling fluid and separated solids. The term “conditioned drilling fluid” is not meant to be limiting and encompasses any fluid that exits the centrifuge (200), whether that fluid is sufficiently conditioned or not.

The separated solids exit the centrifuge (200) via a solids discharge line (210) connected to both the centrifuge (200) and a solids accumulation pit (212). The solids discharge line (210) is configured to transport the separated solids from the centrifuge (200) to the solids accumulation pit (212). The solids accumulation pit (212) is configured to hold a set volume of separated solids. The solids accumulation pit (212) may be any type of container known in the art, such as an above ground/buried tank or a lined/unlined pit dug into the ground.

The conditioned drilling fluid exits the centrifuge (200) via a liquid discharge line (214). The liquid discharge line (214) is connected to the centrifuge (200) and a centrifuge discharge pit (216). The liquid discharge line (214) is designed to transport the conditioned drilling fluid from the centrifuge (200) to the centrifuge discharge pit (216). The centrifuge discharge pit (216) is designed to hold a set volume of the conditioned drilling fluid. The centrifuge discharge pit (216) may be any type of container known in the art, such as an above ground/buried tank or a lined/unlined pit dug into the ground.

A wellbore feed line (218) is connected to the centrifuge discharge pit (216). The wellbore feed line (218) is designed to transport the conditioned drilling fluid from the centrifuge discharge pit (216) to the wellbore (102) or back to the centrifuge feed pit (202). The wellbore feed line (218) may directly or indirectly transport the conditioned drilling fluid from the centrifuge discharge pit (216) to the wellbore (102) or the centrifuge feed pit (202). Further, one or more pieces of equipment, including other mud conditioning equipment (162) may be located between the centrifuge discharge pit (216) and the wellbore (102) or centrifuge feed pit (202) without departing from the scope of the disclosure herein.

In accordance with one or more embodiments, the centrifuge feed pit (202) comprises a first solids content sensor (220) and/or a first specific gravity sensor (222). The first solids content sensor (220) and the first specific gravity sensor (222) may be directly or indirectly connected to the centrifuge feed pit (202) or the centrifuge feed line (206) without departing from the scope of the disclosure herein.

The centrifuge discharge pit (216) comprises a second solids content sensor (224) and/or a second specific gravity sensor (226). The second solids content sensor (224) and the second specific gravity sensor (226) may be directly or indirectly connected to the centrifuge discharge pit (216) or the liquid discharge line (214) without departing from the scope of the disclosure herein.

The first solids content sensor (220) is configured to measure the solids content (in a percentage) of the solids-laden drilling fluid. The first specific gravity sensor (222) is configured to measure the specific gravity of the solids in the solids-laden drilling fluid. The second solids content sensor (224) is configured to measure the solids content of the conditioned drilling fluid. The second specific gravity sensor (226) is configured to measure the specific gravity of any solids still left in the conditioned drilling fluid.

The first solids content sensor (220) and the second solids content sensor (224) may be any type of solids content sensor known in the art such as SiCon OWR Sensor (auto-retort) by Absmart Inc., Solids Level Measurement Technologies by Vega, Suspended Solids Analyzer sensor by Nunes Instruments, or Suspended Solids Analyzer sensor by Sun Scientific Instruments.

The centrifuge (200), the first solids content sensor (220), the first specific gravity sensor (222), the second solids content sensor (224), and the second specific gravity sensor (226) are all electronically connected to the computer (402) system. Due to the electronic connection, the computer (402) system receives the results obtained by the first solids content sensor (220), the first specific gravity sensor (222), the second solids content sensor (224), and the second specific gravity sensor (226).

The computer (402) system may then analyze those results against a set of goal drilling fluid parameters. The goal drilling fluid parameters may be a manual input into the computer (402) system and may be representative of the planned drilling fluid parameters needed to efficiently drill the wellbore (102). The analyzation may include a comparison of the solids content of the drilling fluid before and after the centrifuge (200) conditions the drilling fluid. The analyzation may further include a comparison of the specific gravity of the solids in the drilling fluid before and after the centrifuge (200) conditions the drilling fluid. The computer (402) system may be programmed to look at the comparisons and see if the centrifuge (200) is conditioning the drilling fluid to the required specifications.

Using the analyzed results, the computer (402) system may be able to send an instruction to the centrifuge (200). The instruction may include a first instruction to stop or start the centrifuge or a second instruction to adjust the centrifuge operational parameters. The centrifuge operational parameters may include the speed of the drum rotating in the centrifuge (200).

For example, if the solids content of the conditioned drilling fluid is too high, the computer (402) may send an instruction to the centrifuge (200) to increase the speed of the centrifuge. If the specific gravity of the solids is less than 2.6 (may be categorized as low gravity solids) then the computer (402) may send an instruction to the centrifuge (200) to change the centrifuge speed to be between 2,500 rpm and 3,000 rpm. If the specific gravity of the solids is more than 2.6 (may be categorized as high gravity solids) then the computer (402) may send an instruction to the centrifuge (200) to change the centrifuge speed to be between 1,000 rpm and 1,500 rpm.

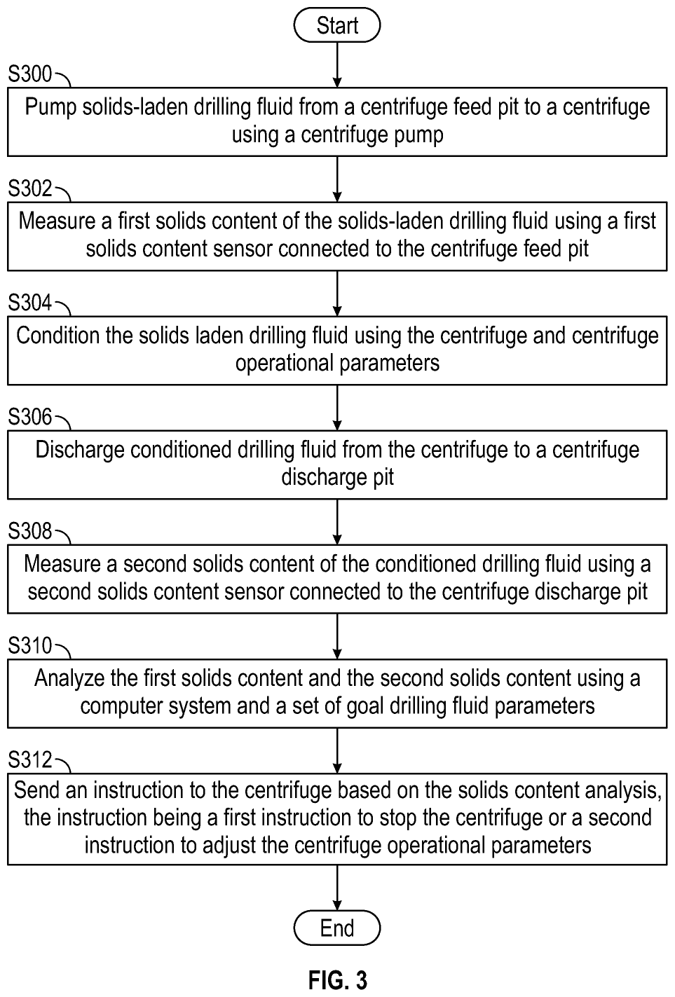

FIG. 3 shows a flowchart in accordance with one or more embodiments. The flowchart outlines a method for conditioning drilling fluid. While the various blocks in FIG. 3 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In step 300, solids-laden drilling fluid is pumped from a centrifuge feed pit (202) to a centrifuge (200) using a centrifuge pump (208). In further embodiments, the solids-laden drilling fluid is pumped to the centrifuge (200) from the centrifuge feed pit (202) via a centrifuge feed line (206). The solids-laden drilling fluid may be pumped to the centrifuge feed pit (202) from the wellbore (102) via a wellbore discharge line (204).

In step 302, a first solids content of the solids-laden drilling fluid is measured using a first solids content sensor (220) connected to the centrifuge feed pit (202). In further embodiments, a first specific gravity of the solids-laden drilling fluid is measured using a first specific gravity sensor (222) connected to the centrifuge feed pit (202). The first solids content sensor (220) and the first specific gravity sensor (222) may be electronically connected to a computer (402) system.

In step 304, the solids laden drilling fluid is conditioned using the centrifuge (200) and centrifuge operational parameters. In accordance with one or more embodiments, the centrifuge (200) separates the solids-laden drilling fluid into separated solids and conditioned drilling fluid. The separated solids may be discharged from the centrifuge (200) into a solids accumulation pit (212) via a solids discharge line (210).

In step 306, conditioned drilling fluid is discharged from the centrifuge (200) to a centrifuge discharge pit (216). The conditioned drilling fluid may be transported from the centrifuge (200) to the centrifuge discharge pit (216) via a liquid discharge line (214). The conditioned drilling fluid may be transported from the centrifuge discharge pit (216) back to the wellbore (102) to be recirculated, or back to the centrifuge feed pit (202) to be reconditioned, via a wellbore feed line (218).

In step 308, a second solids content of the conditioned drilling fluid is measured using a second solids content sensor (224) connected to the centrifuge discharge pit (216). In further embodiments, a second specific gravity of the conditioned drilling fluid is measure using a second specific gravity sensor (226) connected to the centrifuge discharge pit (216).

In step 310, the first solids content and the second solids content is analyzed using a computer (402) system and a set of goal drilling fluid parameters. In further embodiments, the first specific gravity and the second specific gravity are analyzed using the computer (402) system. The first specific gravity and the second specific gravity may be analyzed by classifying the first specific gravity and the second specific gravity as low gravity solids or high gravity solids.

In step 312, an instruction is sent to the centrifuge (200) based on the solids content analysis of step 310. The instruction may include a first instruction to stop the centrifuge (200) or a second instruction to adjust the centrifuge (200) operational parameters. In further embodiments, the instruction is based on the solids content analysis and the specific gravity analysis.

The centrifuge operational parameters may include a speed of the centrifuge (200). The instruction may include increasing the speed of the centrifuge if the second specific gravity is classified as being low gravity solids or decreasing the speed of the centrifuge if the second specific gravity is classified as being high gravity solids. Advantageously, the process of FIG. 3 can be performed in real time, thereby having less impact on drilling fluids properties and drilling performance. Embodiments discussed herein provide a mechanized method that practically and accurately operates the centrifuge remotely, and an automated analyzer content determines the solids content of the drilling fluid inlet and outlet of the centrifuge with less human personnel expose to hazard conditions (high noise).

FIG. 4 shows a computer (402) system in accordance with one or more embodiments. Specifically, FIG. 4 shows a block diagram of a computer (402) system used to provide computational functionalities associated with described algorithms, methods, functions, processes, flows, and procedures as described in the instant disclosure, according to an implementation. The illustrated computer (402) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device.

Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402).

The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a non-transitory computer (402) readable medium, or a memory (406), that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A drilling fluid conditioning system comprising:
a centrifuge configured to receive solids-laden drilling fluid via a centrifuge pump and discharge conditioned drilling fluid and separated solids using centrifuge operational parameters;
a centrifuge feed pit comprising the solids-laden drilling fluid and a first solids content sensor;
a centrifuge discharge pit comprising the conditioned drilling fluid and a second solids content sensor; and
a computer system electronically connected to the first solids content sensor, the second solids content sensor, and the centrifuge, wherein the computer system is configured to analyze results from the first solids content sensor and the second solids content sensor using a set of goal drilling fluid parameters and send an instruction to the centrifuge based on the analyzed results of the solids content sensors and wherein the instruction comprises a first instruction to stop the centrifuge or a second instruction to adjust the centrifuge operational parameters.

2. The drilling fluid conditioning system of claim 1, wherein the centrifuge feed pit further comprises a first specific gravity sensor.

3. The drilling fluid conditioning system of claim 2, wherein the centrifuge discharge pit further comprises a second specific gravity sensor.

4. The drilling fluid conditioning system of claim 3, wherein the computer system is further configured to analyze results from the first specific gravity sensor and the second specific gravity sensor and send the instruction to the centrifuge based on the analyzed results of the specific gravity sensors and the solids content sensors.

5. The drilling fluid conditioning system of claim 1, further comprising a solids accumulation pit comprising the separated solids.

6. The drilling fluid conditioning system of claim 5, further comprising a solids discharge line connected to the centrifuge and the solids accumulation pit and configured to transport the separated solids from the centrifuge to the solids accumulation pit.

7. The drilling fluid conditioning system of claim 1, further comprising a centrifuge feed line connected to the centrifuge and the centrifuge feed pit and configured to transport the solids-laden drilling fluid from the centrifuge feed pit to the centrifuge.

8. The drilling fluid conditioning system of claim 1, further comprising a liquid discharge line connected to the centrifuge and the centrifuge discharge pit and configured to transport the conditioned drilling fluid from the centrifuge to the centrifuge discharge pit.

9. The drilling fluid conditioning system of claim 1, further comprising a wellbore discharge line connected to the centrifuge feed pit and configured to transport the solids-laden drilling fluid from a wellbore to the centrifuge feed pit.

10. The drilling fluid conditioning system of claim 1, further comprising a wellbore feed line connected to the centrifuge discharge pit and configured to transport the conditioned drilling fluid from the centrifuge discharge pit to a drill string.

11. A method for conditioning drilling fluid, the method comprising:
pumping solids-laden drilling fluid from a centrifuge feed pit to a centrifuge using a centrifuge pump;
measuring a first solids content of the solids-laden drilling fluid using a first solids content sensor connected to the centrifuge feed pit;
conditioning the solids laden drilling fluid using the centrifuge and centrifuge operational parameters;
discharging conditioned drilling fluid from the centrifuge to a centrifuge discharge pit;
measuring a second solids content of the conditioned drilling fluid using a second solids content sensor connected to the centrifuge discharge pit;
analyzing the first solids content and the second solids content using a computer system and a set of goal drilling fluid parameters; and
sending an instruction to the centrifuge based on the solids content analyzation, wherein the instruction comprises a first instruction to stop the centrifuge or a second instruction to adjust the centrifuge operational parameters.

12. The method of claim 11, further comprising measuring a first specific gravity of the solids-laden drilling fluid using a first specific gravity sensor connected to the centrifuge feed pit.

13. The method of claim 12, further comprising measuring a second specific gravity of the conditioned drilling fluid using a second specific gravity sensor connected to the centrifuge discharge pit.

14. The method of claim 13, further comprising analyzing the first specific gravity and the second specific gravity using the computer system.

15. The method of claim 14, wherein analyzing the first specific gravity and the second specific gravity further comprises classifying the second specific gravity as low gravity solids or high gravity solids.

16. The method of claim 15, wherein sending the instruction to the centrifuge further comprises sending the instruction to the centrifuge based on the solids content analyzation and the specific gravity analyzation.

17. The method of claim 16, wherein the centrifuge operational parameters comprises a speed of the centrifuge.

18. The method of claim 17, wherein the instruction comprises increasing the speed of the centrifuge if the second specific gravity is classified as being low gravity solids.

19. The method of claim 17, wherein the instruction comprises decreasing the speed of the centrifuge if the second specific gravity is classified as being high gravity solids.

20. The method of claim 11, wherein conditioning the solids-laden drilling fluid further comprises discharging separated solids from the centrifuge to a solids accumulation pit.
